(19) United States
(12) Patent Application Publication
(10) Pub. No.: US 2014/0272151 A1
(43) Pub. Date: Sep. 18, 2014

(54) FAST SET, SOLVENT BOURNE CEMENT BASED COATING

(71) Applicant: CEM-STRIPE, LLC, Fort Myers, FL (US)

(72) Inventor: Kevin Hickman, Centralia, IL (US)

(73) Assignee: CEM-STRIPE, LLC, Fort Myers, FL (US)

(21) Appl. No.: 13/795,805

(22) Filed: Mar. 12, 2013

(51) Int. Cl. C09D 1/08

(52) U.S. Cl. CPC C09D 1/08
USPC 427/341; 524/2; 524/5; 524/8

(57) ABSTRACT

The present invention is directed to cement-based coating compositions providing a stable, hard, fast setting and drying cement coating. In particular, the cement-based coating includes a low-flashing, VOC-exempt solvent in combination with cement materials, aggregates, resins and other optional components. Methods of making, application and use of the cement coating composition are further disclosed herein.

### FIELD OF THE INVENTION

The invention relates to a cement mixture providing a stable, fast setting and drying cement-based coating compositions that is chemical, UV, environmental and corrosion resistant. In particular, the cement mixture employs low-flashing, VOC-exempt solvents. Methods of making the cement-based coating compositions, and methods of application and use of the cement mixture are also disclosed herein.

### BACKGROUND OF THE INVENTION

Surface coatings, such as paint compositions are used in various industries. For example, traffic and other roadway surface paints are often seen in use as white and yellow markings used to demarcate traffic lanes on almost all roads. These roadway surface paints have traditionally been formulated as paint-based compositions including solvent bourne systems, such as systems predominantly employing alkyds and chlorinated rubber-modified alkyds. However, environmental concerns are leading various industries toward alternatives to non-solvent bourne systems.

Waterborne traffic paints have been seen as an alternative to solvent-based systems which commonly employ latex and alkyd and/or chlorinated alkyd solvents (which are known to include volatile organic compounds, also referred to as VOCs, having known environmental concerns associated with ozone depletion). Although the waterborne paint coatings are usually based on acrylic emulsions, producing lower VOC emissions than traditional solvent-based paints, there are various limitations to these more environmentally friendly compositions. For example, the waterborne traffic paints do not provide prompt enough drying time to make their use in the industry convenient and/or feasible for large scale replacement of solvent bourne systems. A further limitation of water bourne traffic paints is that they are less wear-resistant than the solvent bourne systems. It has been found that substantial portions of conventional waterborne traffic markings tend to wear away in less than a few months after exposure to traffic conditions.

Accordingly there is a need for both wear-resistance coating compositions that have quick set times. The failure to provide both characteristics in commercially-available coating compositions results in unnecessary delays and increased production costs, such as in the construction industry.

Accordingly, it is an objective of the claimed invention to develop cement-based coating compositions comprised of substantially inorganic and VOC-exempt components.

A further object of the present invention is a cement-based coating composition that is UV resistant, water resistant, and abrasion resistant.

A further object of the invention is a cement-based coating composition suitable for fast-setting and fast-drying applications of use.

A still further object of the invention is a cement-based coating composition providing highly wear resistant and weather/condition resistant properties which are particularly suitable for long-lasting coating, painting, sealing and/or other applications.

A still further object of the invention is to develop methods of making and applying the cement-based coating compositions.

### BRIEF SUMMARY OF THE INVENTION

The present invention provides compositions and methods of making, applying and employing the compositions. It is an advantage of the present invention that the cement-based coating compositions utilize low-flashing solvents, providing VOC-exempt compositions having durable, wear resistant coatings. In is unexpected according to the invention that the solvents may be employed with cement components, aggregates, resin materials and other optional components to afford unprecedented surface resilience and durability in the form of a rapidly drying and rapidly setting surface coating.

In an embodiment, the present invention provides cement-based coating composition including a first dry formulation portion comprising a cement material and an aggregate source; and a second aqueous formulation portion comprising a low-flash solvent and a resin; wherein the low-flash solvent has a flash point below about 40° F., and wherein the combination of said first and said second portions provides a cement-based coating.

In an embodiment, the present invention provides cement-based coating compositions including from about 10 wt-% to about 50 wt-% of a cement material; from about 5 wt-% to about 50 wt-% of an aggregate source; from about 1 wt-% to about 35 wt-% of a low-flash solvent having a flash point below about 40° F.; and from about 1 wt-% to about 25 wt-% of a resin, wherein the composition is a liquid.

In another embodiment, the present invention provides for a method of using a cement-based coating composition, comprising: applying on a hard surface a layer of the solvent bourne cement-based coating composition, wherein the composition is from about 10 wt-% to about 50 wt-% of a cement material; from about 5 wt-% to about 50 wt-% of an aggregate source; from about 1 wt-% to about 35 wt-% of a low-flash solvent having a flash point below about 40° F.; and from about 1 wt-% to about 25 wt-% of a resin; and thereafter drying/hardening the layer to form a durable, wear resistant, cement-based coating on said surface. Additional method steps for use of the compositions are disclosed herein.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIGS. 1-2 show the measurement of color differences caused in the cement-based coating applications according to various embodiments of the invention after UVB condensation exposure, as set forth in Example 1.

FIGS. 3-4 show the measurement of gloss retention changes caused in the cement-based coating applications according to various embodiments of the invention after UVB condensation exposure, as set forth in Example 1.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The present invention relates to cement-based coating compositions and methods of making, applying and using the same. The cement-based coating compositions have many advantages over conventional, existing coating compositions including for example, substantial strength and durability as a result of the incorporation of cement into the coatings and wear resistance even under exposure to UV radiation from sun and/or other abrasive forces. For example, the cement-based coating compositions are made using low-flashing solvents, providing VOC-exempt compositions having durable, wear resistant coatings. The solidified compositions have flashed off the solvents and retain on a treated surface cement components affording strength and durability for a variety of applications of use.

The embodiments of this invention are not limited to particular cement-based coating compositions and methods of making, using and applying the same, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those active ingredients according to the compositions of the present invention expressed as a percentage minus inert ingredients such as water or salts.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%. In aspects of the invention, the solid cement-based coating compositions are VOC-Free and/or VOC-exempt.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods, systems, apparatuses, and compositions.

While an understanding of the mechanism is not necessary to practice the present invention and while the present invention is not limited to any particular mechanism of action, it is contemplated that, in some embodiments, that the combination of the cement materials and a low-flashing solvent and/or solvent system promote the generation of a cement-based coating providing unprecedented surface resilience and durability while also providing a method of application that rapidly dries and sets as a surface coating. Without being limited to a mechanism of action, the mixture of the cement materials and other components (e.g. aggregates, resins, etc.) releases or flashes off the solvent(s) of the compositions while drawing in air moisture, or another applied source of water moisture, to hydrate the cement materials and solubilize the aggregates, such as glass oxide, silica (or other finely ground sands) or quartz, in order to form a dry, hard, wear-resistant and weather-resistant coating.

Compositions

The present invention provides cement-based coating compositions. In an aspect, the compositions for application to a surface in need of treatment comprise, consist of and/or consist essentially of cement materials and a low-flashing solvent and/or solvent system. In another aspect, the pre-solidified compositions may further comprise, consist of and/or consist essentially of cement materials, a low-flashing solvent and/or solvent system, aggregates and resin materials. In still further aspects, the pre-solidified compositions may further comprise, consist of and/or consist essentially of cement materials, a low-flashing solvent and/or solvent system, aggregates, resin materials, and pigments and/or additional functional ingredients. Still further, any of the pre-solidified compositions may further include a water source.

According to the invention, the pre-solidified compositions have a liquid consistency similar in body to standard paints (e.g. commercially available house paints). In a further aspect, the pre-solidified compositions have a liquid consistency with a total solids in the liquid composition mixture from about 25 wt-% to about 90 wt-%, preferably from about 40 wt-% to about 70 wt-%, and more preferably from about 60 wt-% to about 70 wt-%. In addition, without being limited according to the invention, all ranges recited are inclusive of the numbers defining the range and include each integer within the defined range.

In further aspects, the present invention may be provided in the form of a dry premix of components comprising, consisting of and/or consisting essentially of cement materials and aggregates (and/or pigments and other additional functional ingredients), along with a second portion provided in the form of wet components comprising, consisting of and/or consisting essentially of the low-flashing solvent and/or solvent system and resins, forming a resin solution. The dry and wet premixes are then combined in an embodiment to form the cement-based coating compositions for application to a surface in need of treatment.

In a further aspects, the hardened compositions comprise, consist of and/or consist essentially of cement materials which are solvent-free, VOC-free and/or VOC-exempt, while providing durable, wear resistant coatings. In another aspect, the solidified compositions may further comprise, consist of and/or consist essentially of cement materials, aggregates and resin materials. In still further aspects, the solidified compositions may further comprise, consist of and/or consist essentially of cement materials, aggregates, resin materials, and pigments and/or additional functional ingredients.

In aspects of the invention, a cement-based coating composition is provided that is fast-drying. In additional aspects of the invention, the cement-based coating compositions are fast-solidifying compositions suitable for various applications of use. In still further aspects of the invention, the cement-based coating compositions have adjustable drying and solidifying times based upon the formulation and/or methods of making which are able to adjust drying time to a particular user's desired application. Such compositions may be provided in one or more liquid components, or in the alternative may be provided in one or more liquid components and one or more dry components.

Cement Materials

In an aspect, the cement-based compositions include cement materials. The cement materials are understood to be those which require hydration with a water source for solidification and hardening of the compositions according to the invention. Initially, the cement materials refer to a dry substance that, in the presence of water, acts as a binder to bind other materials together.

An example of cement materials is Portland cement, which shall be understood to include any type of Portland cement (e.g. Types I, II, III, IV and/or White Portland cement). Additionally suitable types of cement materials include calcium aluminate cement and/or combinations of calcium aluminate cement with a Portland cement. Further examples of cement materials may include Class A cement, Class C cement, Class G cement, Class H cement, fly ash, slag cements, volcanic ash, nano-silicates (NS), and any combination thereof. Cements may also include CSA cements or other cements that are subject to hydration. The cement materials are commercially-available from a variety of sources, including for example, Lehigh Cement Company, Lafarge, and Federal White Cement Company.

Portland cements are estimated to be composed of approximately 80% calcium silicates, Ca₃SiO₅ and Ca₂SiO₄, 15% of calcium aluminate and calcium aluminoferrite, Ca₃Al₂O₆ and Ca₄Al₂Fe₂O₁₀, and 5% gypsum, CaSO₄−2H₂O. The cement phases react with water to form cement hydrates. For instance the hydration of calcium silicates leads to the formation of two hydrates, calcium silicate hydrate and calcium hydroxide, which can be shown as follows:

2Ca₃SiO₅+7H₂O→(OH)₄H₄Si₂O₇+3Ca(OH)₂ Eq. 1

2Ca₂SiO₄+5H₂O→Ca₃(OH)₄H₄Si₂O₇+Ca(OH)₂ Eq. 2

The gypsum in Portland cements is known to react with these phases to form calcium trisulfoaluminate hydrate and then calcium monosulfoaluminate hydrate. The amount of gypsum is not sufficient to convert all the calcium aluminate and calcium aluminoferrite into calcium monosulfoaluminate hydrate, some calcium aluminate hydrates are formed as well.

The incorporation of cement materials (e.g. Portland cement) into the cement-based coating compositions of the invention employs hydration for the solidification of the materials; however, due to the combination with low-flashing solvent(s) the process proceeds at an accelerated rate. Without being limited according to the mechanism or theory of the invention, the combination of Portland Cement with aggregate materials (e.g. glass oxides, silicas and/or quartz) are employed with resins to create a solid, glass-like concrete based structure.

Without being limited to a particular theory and/or mechanism of the invention, the hydration of the cement materials in the compositions according to the invention is distinguishable from standard water-to-cement (W/C) weight ratios used in the solidification of conventional cement compositions. For example, according to the invention the solidification of the cement materials disclosed herein for use in the cement-based coating compositions do not employ the conventional W/C ratios; as such the cement materials disclosed herein do not expand to the same volume of water or hydrate around it. Instead, and unexpectedly, the solidification of the cement materials according to the invention does not expand to the full matrix. Instead, the cement materials expand on a smaller scale to the extent that the aggregate materials are solubilized (e.g. a glass aggregate is bound to the cement material in a matrix-like structure) and bound by the cement material. Accordingly, the solidification of the cement materials according to the present invention is distinct from conventional cement solidification for other applications of use than as set forth according to the present invention.

In an aspect, the compositions include from about 1 wt-%-80 wt-% cement materials, from about 10 wt-%-80 wt-% cement materials, from about 1 wt-%-60 wt-% cement materials, from about 5 wt-%-60 wt-% cement materials, preferably from about 10 wt-%-50 wt-% cement materials. In addition, without being limited according to the invention, all ranges recited are inclusive of the numbers defining the range and include each integer within the defined range.

Aggregates

In an aspect, the cement-based compositions include aggregate materials. In an aspect, aggregates include components for use in the compositions for cement to solubilize the surface of in order to create a combination effect of interlocking particles between the aggregate materials and the cement materials. Beneficially, the solubilization of the aggregate materials according to the invention results in a cement-based coating composition having significant strength and wear resistance. In an aspect, the aggregate materials are nanoparticles or provided as nanoparticles.

Exemplary aggregates include glass oxide compositions or other polymeric microspheres, including for example crushed glass and/or sand. In a further aspect, aggregates include silica and/or silicate compositions, including ground silica and/or sand. Additional examples of silica compositions and/or silicate compositions suitable for use as aggregates according to the invention include, for example, amorphous calcium aluminosilicates, including for example calcia-silica-alumina (amorphous calcium aluminosilicate). Any of these aggregates may be provided as or formulated as nanoparticles for use in the compositions according to the invention.

In a further aspect, aggregates include quartz compounds and/or other aggregate fillers for the cement compositions according to the invention. In a still further aspect, aggregates include boron oxide (B₂O₃), sodium oxide (Na₂O), potassium oxide (K₂O), magnesium oxide (Mg₂O), or combinations of the same. Any of these aggregates may also be provided as or formulated as nanoparticles for use in the compositions according to the invention.

A variety of aggregate materials are suitable for use according to the compositions of the invention, wherein the aggregates in combination with the cement material create a solid, glass-like based concrete structure. The aggregates are commercially-available from a variety of sources, including for example, Vitro Minerals and Evonik Industries AG.

In an aspect, the compositions include from about 0.1 wt-%-75 wt-% aggregate materials, from about 1 wt-%-75 wt-% aggregate materials, from about 1 wt-%-60 wt-% aggregate materials, preferably from about 5 wt-%-50 wt-% aggregate materials. In addition, without being limited according to the invention, all ranges recited are inclusive of the numbers defining the range and include each integer within the defined range.

Low-Flashing Solvents

In an aspect, the cement-based compositions include at least one low-flashing solvent. In a further aspect, the low-flashing solvent is a low-ozone depleting or non-ozone depleting material. In an aspect, either a single solvent or a combination of solvents comprised primarily of solvents having flashpoints less than at least 140° F. are employed. In an aspect, either a single solvent or a combination of solvents comprised primarily of solvents having flashpoints preferably less than at least 103° F., preferably less than at least 100° F., preferably less than at least 40° F., less than at least 25° F., less than at least 10° F., or less than at least 5° F. Without being limited according to the invention, all ranges recited are inclusive of the numbers defining the range and include each integer within the defined range. Accordingly, one skilled in the art will ascertain the use of the low-flash solvents of the present invention provide extremely flammable solvents. However, beneficially, the use of the low-flash solvents provides the quick drying of the cement-based coating compositions of the present invention.

In an aspect the solvent is acetone or an acetone equivalent, which is commercially-available from a variety of manufacturers. In another aspect the solvent is heptane or a heptane equivalent, hexane or a hexane equivalent, naphtha or a naphtha equivalent, methyl ethyl ketone or a methyl ethyl ketone equivalent, methyl isobutyl ketone or a methyl isobutyl ketone equivalent, gasoline or a gasoline equivalent, or the like. According to a preferred embodiment, the low-flash solvent is a VOC-exempt solvent, as listed as exempt by the United States of America Environmental Protection Agency (EPA) as applicable as of the filing date of the present invention.

In an aspect, the solvent and/or resin components may be part of a liquid premix formulation that is combined with the dry premix formulation according to certain embodiments of the invention. In such an aspect, the resin is combined with the low-flashing solvent(s) of the invention.

The particular solvents employed in the compositions of the invention are used in place of coagulants and/or other methods for speeding the drying of a coating layer on a surface. For example, instead of adding acidic components into the coating formulations and/or onto a layer of the coating, the solvent systems are built into the coating compositions of the invention and designed to rapidly flash-off from the compositions in order to generate the solidified, hardened and wear resistant coatings of the present invention.

In an aspect, the solvents employed are non-aqueous solvents. In another aspect, the solvents are non-aqueous solvents and may be subsequently combined with water and/or an additional solvent to impact the rate of reaction disclosed herein according to the invention. In an aspect, up to about 10% water is added to a solvent, preferably up to about 5% water is added to a solvent, more preferably from about 0% to about 5%, from about 0% to about 2% water is added to a solvent. In an exemplary aspect, water (or an aqueous solvent) may is added to an acetone solvent to increase the rate of reaction according to the invention.

In an aspect, the compositions include from about 0.1 wt-%-75 wt-% low-flashing solvent(s), from about 1 wt-%-70 wt-% low-flashing solvent(s), from about 0.1 wt-%-50 wt-% low-flashing solvent(s), from about 1 wt-%-50 wt-% low-flashing solvent(s), preferably from about 1 wt-%-35 wt-% low-flashing solvent(s). In addition, without being limited according to the invention, all ranges recited are inclusive of the numbers defining the range and include each integer within the defined range.

In preferred embodiments, the compositions include VOC-exempt solvents. In preferred embodiments, the compositions do not include organic components that are UV sensitive. In preferred aspects of the invention, the non-solidified compositions for application to a surface include VOC-exempt solvents and/or do not include organic components that are sensitive to UV. In further preferred embodiments, the compositions exclude latex. In still further preferred embodiments, the compositions may exclude alkyds and/or other oil-based compounds. In still further preferred embodiments, the compositions may exclude terpentines and/or turpentine-based compounds and/or linseed oil-based compounds.

Resins

In an aspect, the cement-based compositions include resin materials. Resin materials may include a variety of commercially-available resins, including for example, any acrylic monomer resins, acrylic copolymer resin, acrylic blended resin, methacrylates, polyester acrylate resins, acrylic-urethane co-polymers resins, styrene monomer resin, acrylic-styrene copolymer resin, styrene copolymer resin, styrene blended resin, or a combination of any of these resins, particularly a combination of acrylic and styrene resins. The monomers referred to herein also include the use of substituted acrylic and/or substituted styrene monomer resins. Examples of suitable substituted monomers include, for example, alkyl, aryl, alkoxyl, chloro, bromo, iodo, nitro, or combinations of the same. Additional description of suitable resins includes the monomers and polymers disclosed in U.S. Pat. No. 7,645,815, which is herein incorporated by reference in its entirety.

In a further aspect of the invention, a styrene resin material is preferred as a result of its hydrophobic characteristics. The hydrophobicity is further beneficial with a combined styrene and acrylic resin. Without intending to be limited according to any particular theory of the invention, it is beneficial for the styrene component not to absorb water in the composition, leaving any water for hydration and solidification of the cement materials (instead of the resin materials).

A commercially-available example of a suitable resin is a styrene blend acrylic resin, commercially available from JREZ, LLC Resin Manufacturing.

According to an embodiment of the invention, the combination of the resin materials with the cement materials precludes any UV-sensitivity and/or wear resistance concerns that have previously been associated in paint-based coating compositions, such as that disclosed in U.S. Pat. Nos. 6,228,901 and 5,340,870, which are herein incorporated by reference in their entirety. In an aspect, the resins employed according to the invention are not sensitive to UV radiation, such as that which is typically experienced in commercial paint-based coatings.

Beneficially, according to the invention the combination of the cement materials and/or aggregate materials with the resin materials precludes the UV sensitivity of certain resins that have otherwise demonstrated UV sensitivity. For example, the present invention overcomes the limitations in the art relating to use of styrene and/or styrene derivatives which have deleterious effects when subject to UV exposure. However, the present invention overcomes such limitation and is able to include styrenes as particularly suitable resin materials without experiencing any UV sensitivity, such as for example the coating compositions turning yellow or otherwise degrading upon UV exposure. As set forth in the Examples of the invention, the cement-based coating compositions do not exhibit any yellowing and/or UV sensitivity, even with the inclusion of a styrene resin.

In an aspect, the resin component may be part of a liquid premix formulation that is combined with the dry premix formulation according to certain embodiments of the invention. In such an aspect, the resin is combined with the low-flashing solvent(s) of the invention.

In an aspect, the compositions include from about 0.1 wt-%-85 wt-% resin materials, from about 1 wt-%-50 wt-% resin materials, from about 1 wt-%-30 wt-% resin materials, preferably from about 1 wt-%-25 wt-% resin materials. In addition, without being limited according to the invention, all ranges recited are inclusive of the numbers defining the range and include each integer within the defined range.

Additional Functional Ingredients

The components of the cement-based composition can further be combined with various functional components suitable for use in the various applications pursuant to the methods of the invention. In some embodiments, the cement-based compositions for application to a surface in a pre-solidified composition include, cement materials, a low-flashing solvent and/or solvent system, aggregates, resin materials, pigments, and water, which make up a large amount, or even substantially all of the total weight of the cement-based composition. For example, in some embodiments few or no additional functional ingredients are disposed therein.

In other embodiments, additional functional ingredients may be included in the compositions, including both the non-solidified compositions for application to a surface in need of treatment and the solidified compositions applied to a surface. The functional ingredients provide desired properties and functionalities to the compositions. For the purpose of this application, the term “functional ingredient” includes a material that when dispersed or dissolved in a use solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in traffic paints. However, other embodiments may include functional ingredients for use in other applications.

In other embodiments, the compositions may include additional functional ingredients, including for example, pigments, rheology modifiers or thickeners, solubility modifiers, dispersants, stabilizing agents, sequestrants and/or chelating agents, biocides, fragrances and/or dyes, buffers, additional solvents, anti-freeze agents, plasticizers, adhesion promoters, solidification agents, wetting agents, surfactants, light reflectors and/or fluorescence materials, anti-slip additives, preservatives, corrosion inhibitors, anti-flocculants, additional polymers and/or fibers, and the like. In an aspect, the compositions include from about 0 wt-%-60 wt-% additional functional ingredients, from about 0 wt-%-50 wt-% additional functional ingredients, from about 0 wt-%-25 wt-% additional functional ingredients, preferably from about 0 wt-%-10 wt-% additional functional ingredients. In addition, without being limited according to the invention, all ranges recited are inclusive of the numbers defining the range and include each integer within the defined range.

Pigments

In an aspect, the cement-based compositions may further include pigments for color and determination of application. In an aspect, pigments may be either inorganic or organic and are used to provide a color for a particular application of use of the cement-based coating compositions of the invention. For example, a traffic striping application of use may employ a pigment affording a white or a yellow color of the final cement-based coating compositions.

In a preferred aspect, the pigment is titanium dioxide, yellow or black iron oxides and/or organic lead-free yellow. A particularly well suited pigment for use in the compositions is a rutile grade titanium dioxide powder, commercially available from E.I. du Pont de Nemours and Company and other commercial manufacturers. Additional pigments for color may be included in the compositions according to the invention.

In an aspect, the compositions include from about 0 wt-%-35 wt-% pigment, from about 0 wt-%-25 wt-% pigment, from about 0.1 wt-%-25 wt-% pigment, from about 1 wt-%-25 wt-% pigment, preferably from about 1 wt-%-15 wt-% pigment. In addition, without being limited according to the invention, all ranges recited are inclusive of the numbers defining the range and include each integer within the defined range.

Light Reflectors and Fluorescence Materials

In a further aspect, light reflectors may be used alone or in combination with pigments or other colorants for a particular coating composition. In an aspect, glass beads or particles may be employed as a light reflector. In an aspect of the invention, such light reflectors may be formulated into the compositions and/or applied before or after the coating of the composition is applied to be disposed on such coating. In a preferred aspect, light reflectors are applied over the top of a cement-based coating according to the invention in an amount sufficient to provide visibility of the coating under dark and/or wet conditions. The amount and/or application rate of glass beads and/or other light reflectors are known in the art and further described in U.S. Pat. No. 6,228,907, which is herein incorporated by reference in its entirety.

In a further aspect, fluorescence materials may be used alone or in combination with pigments or other colorants for a particular coating composition. Examples of suitable fluorescence materials include for example, halide mineral compositions, including Fluorospar®. Natural mineral containing fluorine, such as black or brown Fluorospar, are particularly well suited for providing a fluorescent characteristic to a coating according to the invention.

In an aspect of the invention, such fluorescence materials may be formulated into the compositions and/or applied before or after the coating of the composition is applied to be disposed on such coating. In a preferred aspect, fluorescence materials are applied over the top of a cement-based coating according to the invention in an amount sufficient to provide visibility of the coating under dark conditions.

Polymers and/or Fibers

In an aspect, the cement-based compositions may further include fibers, such as volcanic fibers, mineral fibers and/or synthetic fibers (e.g. polyester fibers) to afford increased strength to the solidified cement-based coating compositions of the invention. In an aspect, such fibers may be either natural and/or synthetic fibers. An example of a particularly well suited fiber is commercially-available under the tradename Wollanstonite Nyad®-G (Nyco Minerals). Without being limited to a particular theory of the invention, the incorporation of fibers provides a mechanism of entanglement with the cement materials and/or aggregate materials according to the compositions disclosed herein, providing further strength and/or flexibility to the coating compositions. In an aspect, the compositions include from about 0 wt-%-40 wt-% polymers and/or fibers, from about 0.1 wt-%-20 wt-% polymers and/or fibers, from about 1 wt-%-20 wt-% polymers and/or fibers, preferably from about 1 wt-%-10 wt-% polymers and/or fibers. In addition, without being limited according to the invention, all ranges recited are inclusive of the numbers defining the range and include each integer within the defined range.

Rheology Modifiers or Thickeners

In an aspect, the cement-based compositions may further include thickeners, such as xanthum gum, guar gum, polyvinyl alcohols, hydroxyethyl cellulose (or related cellulosic thickeners), clay or the like. In an aspect, fumed and/or treated silicas may be employed as thickeners. Such types of silica suited for use in the compositions of the invention as thickeners include both fumed silica and/or anhydrous fumed silicates (whether treated or untreated), such as those commercially-available under the tradename Aerosil®-200. Without being limited to a particular theory of the invention, the incorporation of such thickeners provide broken edges that further allow interlocking of the cement-based coating to hold it in place and provide additional strength to the compositions.

In an aspect, the thickening agents may be added into the dry formulations for use in the cement-based coating compositions of the invention to provide a desired viscosity or rheology of the liquid compositions.

In an aspect, the compositions include from about 0 wt-%-40 wt-% thickeners, from about 0.1 wt-%-20 wt-% thickeners, from about 1 wt-%-20 wt-% thickeners, preferably from about 1 wt-%-10 wt-% thickeners. In addition, without being limited according to the invention, all ranges recited are inclusive of the numbers defining the range and include each integer within the defined range.

Additional Solvents

In an aspect, the cement-based compositions may further include additional solvents to assist in controlling the dry time or solidification time of the cement-based coating compositions according to the invention. In an aspect, a preferred additional solvent is a VOC-exempt solvent. In an aspect, a preferred additional solvent is either a high or low flash solvent. In a still further preferred aspect, the additional solvent is N-Propyl Acetate or Oxsol 100. A preferred additional solvent is tertiary butyl acetate (TBAc), which is commercially available from a variety of manufacturers including Lyondell Basell Industries. In an aspect, the compositions include from about 0 wt-%-40 wt-% additional solvents, from about 0.1 wt-%-35 wt-% additional solvents, from about 0.1 wt-%-20 wt-% additional solvents, from about 1 wt-%-20 wt-% additional solvents, preferably from about 1 wt-%-15 wt-% additional solvents. In addition, without being limited according to the invention, all ranges recited are inclusive of the numbers defining the range and include each integer within the defined range.

### EMBODIMENTS

Exemplary ranges of the cement-based coating compositions according to the invention are shown in Tables 1 and 2 in weight percentage of the non-solid and solid compositions, respectively. It is to be understood that the non-solid compositions are in the form of a liquid slurry (e.g. dry powder mixed with liquid components), which may be further referred to herein as a coating slurry. According to the invention, the composition is not an emulsion and/or a dispersion. The compositions are considered stable slurries, as such the liquid compositions will not polymerize and/or undergo chemical reactions. Instead, the liquid compositions are stable slurries providing for long term liquid stability.

TABLE 1
(Liquid Formulation)

| | First | Second | Third | Fourth |
|---|---|---|---|---|
| | Exemplary | Exemplary | Exemplary | Exemplary |
| Material | Range wt-% | Range wt-% | Range wt-% | Range wt-% |
| Cement | 1-80 | 1-60 | 5-60 | 10-50 |
| Materials | | | | |
| Solvent(s) | 0.1-75 | 0.1-50 | 1-50 | 1-35 |
| Aggregates | 0.1-75 | 1-70 | 1-60 | 5-50 |
| Resins | 0.1-50 | 1-50 | 1-30 | 1-25 |
| Additional | 0-60 | 0-25 | 0-20 | 0-10 |
| Functional | | | | |
| Ingredients | | | | |

TABLE 2
(Solid Composition)

| | First | Second | Third | Fourth |
|---|---|---|---|---|
| | Exemplary | Exemplary | Exemplary | Exemplary |
| Material | Range wt-% | Range wt-% | Range wt-% | Range wt-% |
| Water/Liquid | 0 | 0 | 0 | 0 |
| Component | | | | |
| Cement | 1-80 | 1-60 | 5-60 | 10-50 |
| Materials | | | | |
| Solvent(s) | 0 | 0 | 0 | 0 |
| Aggregates | 0.1-75 | 1-70 | 1-60 | 5-50 |
| Resins | 0.1-50 | 1-50 | 1-30 | 1-25 |
| Additional | 0-60 | 0-25 | 0-20 | 0-10 |
| Functional | | | | |
| Ingredients | | | | |

The coating compositions may include concentrate compositions, may be diluted to form use or ready-to-use compositions (either on site or in a pre-formulated manner). In general, a concentrate refers to a composition that is intended to be diluted with water, or other applicable solvent, to provide a use solution that contacts an object to provide the desired coating composition. The coating composition that contacts the surface to be treated or coated according to the invention can be referred to as a concentrate or a use composition (or use composition) dependent upon the formulation employed in methods according to the invention. It should be understood that the amounts and/or percent actives of the cement materials, resins, solvents, aggregates and other optional functional ingredients in the coating compositions will vary depending on whether the compositions are provided as a concentrate or as a use composition, along with the particular applications of use of the coating composition.

Methods of Making

According to an embodiment of the invention the cement-based compositions may be made by combining dry and liquid compositions to form the liquid cement-based coating compositions suitable for applying in liquid form to a surface in need of coating. In an aspect, the combination of the dry and liquid compositions comprises providing a first dry component comprising, consisting of and/or consisting essentially of cement materials, aggregates and optionally pigments and/or additional optional ingredients, with a second liquid portion comprising, consisting of and/or consisting essentially of a low-flashing solvent, a resin and optionally additional solvents. The method of making may further involve the addition of a water source.

In an aspect of the invention, the liquid compositions have a consistency similar to standard paints (e.g. commercially available house paints). Such liquid cement-based coating compositions may be packaged and stored for future applications and use and/or may then be used on site for a particular application of use. As one skilled in the art shall ascertain, the liquid cement-based coating compositions will not proceed to any chemical reaction or drying off until the composition is either exposed to air (allowing the solvent(s) and/or water to evaporate off) and/or applied to a surface as the coating (also allowing solvent(s) and water to evaporate) and thereby hardening the compositions.

Without being limited to a particular theory of the invention, the combining of the dry and liquid compositions allows the saturation of the dry components with the low-flash solvent(s) and the resin materials. Thereafter, upon applying the composition to a surface for coating according to the methods of use disclosed herein, the solvent (e.g. acetone) and/or solvents, if applicable, are readily flashed off from the mixture or composition. During this flashing off, the solvent(s) leave the cement materials quickly due to its low flash-point, which are replaced with moisture from the air, or moisture directly applied to the composition. The sudden uptake of moisture activates and hydrates the cement materials causing the cement to solubilize the aggregates and create a solid, hard, cement-based coating with a very short dry-time.

Applications of Use

According to an embodiment of the invention the cement-based compositions are suitable for use in a variety of applications in need of substantially inorganic coating compositions. The compositions are particularly suitable for applications in need of coating compositions that are UV resistant, have no reportable VOCs, and/or provide water and/or wear resistance. The compositions are further suitable for applications in need of coating compositions that have fast drying and hardening times, such that the time from application to the final composition state of a hardened, durable coating is minimized.

For example, applications of use requiring these compositional characteristics for coating compositions include those requiring high abrasion resistance associated with coating applications for use as traffic stripe paint. As one skilled in the art appreciates, traffic stripe paints require a highly wear resistant and long lasting coating to minimize wear and tear as well as the frequency for re-application. Use of the cement-based compositions for traffic paint applications further allows the formulation of the compositions to include incorporation of various pigments/colors commonly used in traffic paints (e.g. white, yellow, black, blue, etc.). Such applications of use for the cement-based compositions are particularly suited for use in and/or on highways, interstates, county and city roads, and the like.

In addition to the traffic stripe paint coating applications, the cement-based coating compositions are additional suitable for use in asphalt shingle roof coatings, pool and/or other types of underwater coatings, parking lot and driveway striping, airport and/or other non-traffic striping applications, non-slip and/or slip-resistant coatings on any hard surfaces, overlays for bridges, walkways, driveways, etc., metal coatings, plastic coatings (including for example polystyrene, polyethylene, ABS, polyurethane, polyethylene terphthalate, polybutylene terphthalate, polypropylene, polyphenylene, polycarbonate, polyacrylate), and the like.

In an additional aspect, the cement-based coating compositions can be applied to substrates and/or hard surfaces at a variety of temperatures and/or conditions. In an aspect of the invention, the compositions can be applied to surfaces and/or substrates having temperatures, for example up to about 300° F., or more particularly from about 180° F. to about 300° F. without performance failures. In additional preferred aspects, the compositions are preferably applied to surfaces and/or substrates having temperatures up to about 200° F. without performance failures.

In the various applications of use described herein, the cement-based compositions provide suitable replacements for all currently-available painting and/or coating products. Beneficially, replacement with the cement-based compositions of the invention would increase longevity of coatings, for example line strips in all roadways and interstates, as a result of high durability and abrasion resistance afforded by the cement-based compositions. In addition, the compositions being completely VOC-exempt places no limitations on the use and/or application of the products, such as for example as a result of EPA, or other State or Local, guidelines on VOC contents. Further, as the cement-based compositions are primarily made from recycled products, such as recycled glass and by-product acetone, the cement-based compositions are also considered “Green” products and may further have LEED credits. These and other benefits of the cement-based compositions described according to the invention set forth the benefits of use within the various applications of use.

In an aspect, the method of use may include an initial step of forming the ready-to-use cement-based coating composition. In such an aspect, the dry premix of components comprising, consisting of and/or consisting essentially of cement materials and aggregates (and/or pigments and other additional functional ingredients), is combined with a liquid (or wet) premix of components comprising, consisting of and/or consisting essentially of the low-flashing solvent and/or solvent system and resins. In such an aspect, the combination of the dry and wet premixes may be done on-site for use thereafter to provide a specific amount of cement-based coating compositions for application to a surface. In an alternative aspect, the cement-based coating composition may be provided in a ready-to-use liquid single formulation (already having combined the two pre-mix components). In an aspect, the methods of use include applying the compositions to a surface in need of a coating. The application of a layer of the coating composition according to the invention may be repeated to apply more than one layer to a surface. Suitable surfaces include for example roads, including routes, highways, airport runways, exit and entry ramps, passes, pavements, sidewalks or parking lots for vehicles, such as, autos, bikes, trucks. Roads as referred to herein are most often paved surfaces containing for example, asphalt, wood, metal and/or concrete. Additional suitable surfaces include roofs, pools, spas and other underwater surfaces requiring various coatings or painting, surfaces having non-slip and/or slip-resistant coatings, and the like.

In an aspect, the application step may first involve cleaning the surface to be treated with the cement-based coating compositions of the invention. For example, surfaces are preferably free of loose dirt and/or debris, including for example oils, grease, water, moisture, dust, scale, or any un-adhered coatings. Beneficially, the coating compositions of the invention do not require any surface etch and will bond to extremely smooth surfaces.

As referred to herein, the applying step may be completed by a machine and/or may be completed manually, as such methods are well known in the art. A mechanical application may employ using various machines and/or devices as may be known to those skilled in the art. For example, the application may employ spraying the coating composition through conventional means such as a vehicle mounted pressurized tank and application gun or other spraying device. Alternatively, the application may employ an alternative airless pump. Alternatively, the compositions may be manually applied or painted onto a surface in need of treatment, such as applied with a paint brush, roller or other device for applying a coating. In addition, the application step is not limited to the patterns, thickness, shape and/or colors of application. For example, in the case of traffic markings, the application may include the use of solid, transverse and/or interrupted stripes. These and other modifications of the particular application are understood by skilled artisans to be dictated by the particular application of use, which are included within the scope of the invention.

In an aspect of the invention, the methods of using may further include the step of solubilizing the cement materials and aggregate materials to form the solid, hard, cement-based coating according to the invention. In such a step, the solvent(s) leave the cement materials quickly due to its low flash-point. In a further aspect, the solvent(s) are replaced with moisture from the air (or another source provided to the composition) to hydrates the cement materials causing the cement to solubilize the aggregates and create a solid, hard, cement-based coating with a very short dry-time.

In an aspect of the invention, the methods of using may further include the step of adding additional solvents (e.g. TBAc) and/or moisture to a composition (either before it is applied to a surface or after) to impact or change the drying time of the composition. Beneficially, the compositions of the invention once applied to a surface and exposed to ambient conditions will promptly flash off the low-flash solvent(s) of the composition and hydrate the cement materials and aggregate materials with moisture from the atmosphere. In some aspects, additional moisture (e.g. a water source including any potable water) may be added to the coating to decrease the hardening time (i.e. set time) as may be desired for a particular application of use. For example, in low relative humidity conditions additional moisture may be added to a surface of the coating to speed up the set time for the coating composition.

In some aspect, the addition of a water source to the applied coating may be referred to as “water fogging” and rapidly increases the rate of hardening. The application of the water is preferably in the form of a mist of the water source. The mist would be applied directly over the coating composition that has been applied to the surface, effectively providing high humidity conditions (e.g. 100% humidity when water mist covers the coating). For example, in applications of use requiring very quick dry or set time, such as traffic painting wherein cars will be promptly driving over the newly coated surfaces, a water fogging step is highly desirable. According to the invention, the use of water over a solvent-bourne coating for improved drying is highly counterintuitive and an unexpected solution to the problem in the art. Without being limited to a particular theory of the invention, the use of additional water in a solvent-bourne system is counterintuitive when the goal of the invention (forming a solid, hardened coating) is to remove solvents, such as water soluble or water miscible solvents, from the coating composition itself.

As one skilled in the art will ascertain, the application of the water source, such as in the form of a mist, may be administered using various mechanisms and/or machines, including for example, atomizers, misters, paint sprayers and/or other pressurized pumps and the like for controlling the misting of a water source onto a coating composition on a treated surface.

In other aspects the dry time of the compositions may need to be slowed down. In such embodiments, additional solvents (e.g. TBAc) may be added to the compositions. For example, in locations having high relative humidity and/or heat as ambient conditions, the dry/set time for the compositions may need to be slowed down. For purposes of further example, in such conditions it may be desirable to slow the dry time to more than about 30 seconds, or more than about 10 minutes, depending on application requirements.

In a further aspect, the methods of use further include the drying of the compositions on a surface. The drying step may include providing a period of time where nothing contacts the drying coating composition.

In an aspect, the rate of flashing off of the solvents and hydrating of the cement and aggregates to form the solid composition will vary dependent upon the ambient conditions of the location of the surface to be treated. For example, the higher the atmospheric humidity, the shorter time it will take for the composition to solidify, shortening the no-pick-up time for the layer on the treated surface. In addition, as one skilled in the art will ascertain, the thickness of the coating layer will further impact the rate of the flashing off of the solvents and hydrating of the cement and aggregates to form the solid composition. For further example, the greater the thickness of the layer of coating applied to a surface, the longer it will take for the composition to solidify, increasing the no-pick-up time for the layer on the treated surface.

Beneficially, the VOC-exempt solvent systems overcome the significant limitation of water bourne systems in their fast dry time. In another aspect, the compositions of the invention do not require more than a few minutes to dry or harden. In another aspect, the compositions dry within less than 10 minutes, preferably within less than 5 minutes, preferably within less than 1 minute, and more preferably within less than 30 seconds. In another preferred aspect, the hardening is near instantaneous (e.g. within about 3-4 seconds), such as methods of use involving water fogging and/or drying under high humidity conditions. In addition, without being limited according to the invention, all ranges recited for the dry time of the compositions are inclusive of the numbers defining the range and include each integer within the defined range. This represents a very fast dry time or “no-pickup time” that is convenient for applications which require prompt use under normal conditions (e.g. highway painting wherein traffic is only kept of the surfaces for as short a period of time as possible).

As referred to herein, when referring to “dry,” “set,” “hardening” or “no-pickup” time this refers to a layer of the coating composition after application to a surface and the physical property development of the coating into a solid composition, and is not necessarily an indication of water content remaining in the coating. However, when referring to “drying” step of the methods of the invention, the remaining amount of solvent(s) in the coating composition is minimal, such that approximately no solvent(s) content can be measured in the coating composition affixed to the treated surface. Without limiting the scope of the invention, in addition to the drying time for the compositions, the coating compositions are further air cured over a period of about 24 hours, imparting additional strength to the compositions. In other aspects, the air cure period is less than 24 hours to provide the maximum hardness for the compositions. In some aspects, maximum hardness may be achieved in about 7 days, in other embodiments in about 3 days.

In another aspect, the methods of use may also include the hardening and/or solidifying of the composition on a treated surface to provide a wear resistance coating according to the invention. In an aspect, the wear resistance of the cement-based coating compositions is provided for at least months to years of wear resistance, preferably at least 3 years (meeting standards for long-term coatings for certain applications of use), preferably at least 5 years and more preferably at least 10 years. Without being limited according to the invention, all ranges recited are inclusive of the numbers defining the range and include each integer within the defined range.

In another aspect, the methods of use may also include a measuring step to confirm the wear resistance of the compositions of the invention. As referred to herein, the term “wear resistance” means the degree of resistance of the coating (e.g. traffic markings) to loosen and/or detaching from the treated surface when the marking is exposed to the wear, abrasion (e.g. traffic conditions) and/or exposure to UV degradation. Wear resistance can be expressed as the percentage area of a coating on a surface remaining after its extended exposure. In an aspect of the invention, at least about 75% wear resistance of a surface coated according to the invention is provided, preferably at least about 90% wear resistance of a surface coated according to the invention is provided, and more preferably about 100% wear resistance of a surface coated according to the invention is provided. In addition, without being limited according to the invention, all ranges recited for the wear resistance of the coating compositions are inclusive of the numbers defining the range and include each integer within the defined range. Beneficially, the wear resistance afforded by the cement-based coating compositions of the invention exceeds that of conventional waterborne coatings (e.g. traffic markings which tend to wear away in less than a few months after exposure to accelerated traffic conditions).

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Panels of the cement-based coating compositions were evaluated for gloss retention and color difference upon UV-condensation exposure. Six test panels were provided for evaluation of UV-condensation exposure. The panels each have a white coating over concrete substrate. The panels were numbered randomly 1-6, using the cement-based coating composition shown in Table 3.

TABLE 3

| | Range wt-% |
|---|---|
| Material | Panels 1-6 |
| Cement Materials | 10-50 |
| Solvent(s) | 1-35 |
| Aggregates | 10-55 |
| Resins | 1-25 |
| Synthetic Fiber | 1-10 |
| Pigment | 1-15 |
| Thickener | 0.1-20 |
| Additional Solvent | 0.1-15 |

Initial gloss and color readings were taken prior to the panels being placed in UV-condensation cabinet for environmental exposure. Because of the low gloss levels of the panels, gloss was monitored at 60° and 85° viewing angles. Panels were placed in UV-condensation cabinet on a cycle of 4 hours UVB (313 nm) exposure at 60° C., followed by 4 hours Condensation at 50° C. Successive measurements were taken after 115, 256, and 428 hours of UV-condensation exposure, which are representative of years of UV exposure on outdoor conditions (e.g. such as a road wherein the cement-based coating composition may be applied for use in marking traffic lines).

Results: Panel 2 showed the most color change, predominantly yellowing, over 428 hours UV-condensation exposure. There has been little differentiation detected among the six provided samples for gloss retention (such testing remains ongoing for UV-condensation). No film integrity deterioration has been detected on any of the provided samples. The FIGS. 1-4 show color difference (FIGS. 1-2) and gloss retention performance (FIGS. 3-4).

The measurement of color difference (0 color change is the best) uses the following as depicted in FIGS. 1-2:

Range of Δb* for yellowing for all samples was +1.5-2.5.

Panel 2 shows the most yellowing and some darkening through the UVB exposure period.

Panel 3 was the only panel other than Panel 2 to show darkening however it had the lowest Δb* along with panel 6 after 428 hours exposure.

Panel 6 performed favorably for yellowing, Δb*, during the exposure intervals.

The measurement of Gloss Retention (100% is optimum performance) uses the following as depicted in FIGS. 3-4:

Initial gloss levels ranged from 1.6-2.1 at 60° and from 0.3-1.6 at 85° (wherein ° refers to the angle of the gloss measurement).

Panel 3 showed slight increase in gloss at 60° and a 67% increase—however only an increase from 0.3 to 0.5 units—at 85°.

There was little differentiation among the other 5 panels for gloss retention through 428 hours exposure.

The results of the experimentation demonstrate the wear resistance of the cement-based coating compositions of the invention. Even after the equivalent of years of harsh UV exposure (the most destructive force affecting conventional paint-based coatings), the compositions according to the invention retain appearance and wear resistance.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. A cement-based coating composition comprising:
a first dry formulation portion comprising a cement material and an aggregate source; and
a second aqueous formulation portion comprising a low-flash solvent and a resin;
wherein the low-flash solvent has a flash point below about 140° F.,
wherein the combination of said first and said second portions provides a cement-based coating.

2. The composition of claim 1, wherein the cement material is a Portland cement, calcium aluminate cement or combinations of the same and comprises from about 5 wt-% to about 80 wt-% of the composition.

3. The composition of claim 1, wherein the aggregate source is a glass oxide composition, silica composition, silicate composition, calcia-silica-alumina (amorphous calcium aluminosilicate), boron oxide (B₂O₃), sodium oxide (Na₂O), potassium oxide (K₂O), magnesium oxide (Mg₂O), or combinations of the same, and comprises from about 1 wt-% to about 75 wt-% of the composition.

4. The composition of claim 1, wherein the low-flash solvent is a solvent having a flash point below about 140° F. and comprises from about 1 wt-% to about 70 wt-% of the composition.

5. The composition of claim 4, wherein the low-flash solvent is acetone or another solvent having a flash point below about 10° F.

6. The composition of claim 1, wherein the resin is an acrylic monomer resin, acrylic copolymer resin, acrylic blended resin, acrylic-urethane copolymer resin, styrene monomer resin, styrene copolymer resin, acrylic-styrene copolymer resin, styrene blended resin, substituted acrylic and/or styrene resins, methacrylate resin, polyester acrylate resin or combinations of the same and comprises from about 1 wt-% to about 50 wt-% of the composition.

7. The composition of claim 1, wherein the composition further comprises a pigment from about 0.1 wt-% to about 35 wt-% of the composition.

8. The composition of claim 1, wherein the composition further comprises an additional functional ingredient selected from the group consisting of pigments, rheology modifiers or thickeners, solubility modifiers, dispersants, stabilizing agents, sequestrants and/or chelating agents, biocides, fragrances and/or dyes, buffers, additional solvents, anti-freeze agents, plasticizers, adhesion promoters, solidification agents, wetting agents, surfactants, light reflectors, anti-slip additives, preservatives, corrosion inhibitors, anti-flocculants, additional polymers and/or fibers, and combinations of the same.

9. A cement-based coating composition comprising:
from about 10 wt-% to about 80 wt-% of a cement material;
from about 5 wt-% to about 75 wt-% of an aggregate source;
from about 1 wt-% to about 70 wt-% of a low-flash solvent having a flash point below about 140° F.; and
from about 1 wt-% to about 50 wt-% of a resin, wherein the composition is a liquid.

10. The composition of claim 9, wherein the cement material is a Portland cement, calcium aluminate cement or combinations of the same, wherein the aggregate source is a glass oxide composition, silica and/or silicate composition, amorphous calcium aluminosilicate (calcia-silica-alumina), or combinations of the same, wherein the resin is wherein the resin is an acrylic monomer resin, acrylic copolymer resin, acrylic blended resin, acrylic-urethane copolymer resin, styrene monomer resin, styrene copolymer resin, styrene blended resin, substituted acrylic and/or styrene resins, acrylic-styrene copolymer resin, methacrylate resin, polyester acrylate resin or combinations of the same, and wherein the low-flash solvent is acetone or another solvent having a flash point below about 10° F.

11. The composition of claim 10, wherein the liquid composition has a total solids in the composition mixture from about 40 wt-% to about 85 wt-%.

12. The composition of claim 10, wherein the low-flash solvent is acetone or another solvent having a flash point below about 10° F.

13. The composition of claim 10, wherein the composition further comprises a pigment and/or an additional functional ingredient selected from the group consisting of rheology modifiers or thickeners, solubility modifiers, dispersants, stabilizing agents, sequestrants and/or chelating agents, biocides, fragrances and/or dyes, buffers, additional solvents, anti-freeze agents, plasticizers, adhesion promoters, solidification agents, wetting agents, surfactants, light reflectors, anti-slip additives, preservatives, corrosion inhibitors, anti-flocculants, additional polymers and/or fibers, and combinations of the same.

14. A solidified cement-based coating composition comprising:
from about 10 wt-% to about 80 wt-% of a cement material;
from about 5 wt-% to about 75 wt-% of an aggregate source; and
from about 1 wt-% to about 50 wt-% of a resin;
where said composition provides a wear-resistant and UV-resistant cement-based coating.

15. The composition of claim 14, wherein the cement material is a Portland cement, calcium aluminate cement or combinations of the same, wherein the aggregate source is a glass oxide composition, silica and/or silicate composition, amorphous calcium aluminosilicate (calcia-silica-alumina), or combinations of the same, and wherein the resin is wherein the resin is an acrylic monomer resin, acrylic copolymer resin, acrylic blended resin, acrylic-urethane copolymer resin, styrene monomer resin, styrene copolymer resin, styrene blended resin, substituted acrylic and/or styrene resins, acrylic-styrene copolymer resin, methacrylate resin, polyester acrylate resin or combinations of the same.

16. The composition of claim 15, wherein the composition was produced by the process of combining said cement material, said aggregate source and said resin with a low-flash solvent having a flash point below about 140° F.

17. The composition of claim 16, wherein the low-flash solvent has a flash point of below about 40° F.

18. The composition of claim 17, wherein the low-flash solvent is acetone or another solvent with a flash point below about 10° F.

19. The composition of claim 14, wherein the composition further comprises a pigment and/or an additional functional ingredient selected from the group consisting of rheology modifiers or thickeners, solubility modifiers, dispersants, stabilizing agents, sequestrants and/or chelating agents, biocides, fragrances and/or dyes, buffers, additional solvents, anti-freeze agents, plasticizers, adhesion promoters, solidification agents, wetting agents, surfactants, light reflectors, anti-slip additives, preservatives, corrosion inhibitors, anti-flocculants, additional polymers and/or fibers, and combinations of the same.

20. A method of using a cement-based coating composition, comprising:
applying on a hard surface a layer of the solvent-bourne cement-based coating composition of claim 1; and
drying and/or hardening of the layer to form a durable, wear resistant, cement-based coating on said surface through flash hydration, wherein
the low flash solvent rapidly evaporates and exchanges its volume with air mass that contains water moisture to rapidly hydrate the cement material to interlock particles of the cement material with
the aggregate source and optionally pigments and/or functional additives to rapidly set up and harden as a wear-resistant and UV resistant surface cement-based coating.

21. The method of claim 20, wherein the cement material is a Portland cement, calcium aluminate cement or combinations of the same, wherein the aggregate source is a glass oxide composition, silica and/or silicate composition, amorphous calcium aluminosilicate (calcia-silica-alumina), or combinations of the same, wherein the resin is wherein the resin is an acrylic monomer resin, acrylic copolymer resin, acrylic blended resin, acrylic-urethane copolymer resin, styrene monomer resin, styrene copolymer resin, styrene blended resin, substituted acrylic and/or styrene resins, acrylic-styrene copolymer resin, methacrylate resin, polyester acrylate resin or combinations of the same, and wherein the solvent is acetone or another solvent having a flash point below about 10° F.

22. The method of claim 20, wherein said low-flash solvent has a flash point below about 20° F. and is flashed off said composition to form the dried layer of cement-based coating on said surface.

23. The method of claim 20, wherein the drying step is complete within less than 10 minutes.

24. The method of claim 20, wherein the method further comprises the steps of adding a water source (e.g. water fogging) to decrease the time of drying and/or hardening from less than 30 minutes to a few seconds.
